(19) United States
(12) Patent Application Publication
(10) Pub. No.: US 2020/0307004 A1
(43) Pub. Date: Oct. 1, 2020

(54) UNIVERSAL GUIDE BLADE FOR HAIR CLIPPER

(71) Applicant: HONG SEOG HAM, Seoul (US)

(72) Inventor: HONG SEOG HAM, Seoul (US)

(21) Appl. No.: 16/425,904

(22) Filed: May 29, 2019

(30) Foreign Application Priority Data
Apr. 1, 2019 (KR) 20-2019-0001330

(51) Int. Cl. B26B 19/38; B26B 19/20

(52) U.S. Cl. CPC B26B 19/3813; B26B 19/20

(57) ABSTRACT

A universal guide blade for a hair clipper is provided, which includes a guide body having a cutting guide formed on a front side, and a plurality of attaching grooves spaced apart from each other at predetermined intervals formed on a rear side of the cutting guide, a guide fixing part formed at a center of a rear side of the guide body and having a mounting protrusion for fixing to and separating from a detachable-type hair clipper, and a fixing member inserted into the attaching grooves and fixing the guide blade to a fixed-type hair clipper by a predetermined elastic force.

### CROSS-REFERENCE TO RELATED APPLICATIONS

The present disclosure claims priority to Korean Utility Model Application No. 20-2019-0001330 in the Republic of Korea, the disclosures of which are incorporated herein by reference.

### TECHNICAL FIELD

The present disclosure relates to a universal guide blade for a hair clipper, and more specifically, to a universal guide blade for an electric hair clipper, which can be used in both a fixed-type hair clipper and a detachable-type hair clipper.

### BACKGROUND

Generally, a hair clipper is an implement used for cutting human head hair, animal hair, and the like, and it is categorized into a manual type and an electric type. For the electric type hair clipper, a guide blade is separately provided to keep the length of hair cut at a constant level, and the guide blade can be categorized as a fixed-type hair clipper and a detachable-type hair clipper according to a manner of attaching.

For example, Korean Patent Registration No. 10-0909181 (Patent Document 1) discloses a fixed-type hair clipper comprising: a housing; a rotatable blade assembly detachably connected to the housing, having two or more cutting edges diametrically opposed to each other and a single cutting surface, and configured to selectively rotate about an axis perpendicular to the cutting surface; a blade switching mechanism operatively connected to the blade assembly to selectively release the blade assembly and accordingly rotate the blade assembly about the axis.

Additionally, Korean Patent Application Laid-Open No. 10-2018-0039594 (Patent Document 2) discloses a guide blade provided in a detachable-type hair clipper, in which, in a comb tooth cap detachably attached to an electric hair clipper including a main body including a hair clipper body having a motor built therein and a head portion disposed in front of the hair clipper main body; and a blade portion provided on a front end of the head portion, in which the comb tooth cap includes a plate-shaped base portion, a plurality of combs extending from a front of the base portion, and an elastic fixing piece including, at one end thereof, a fixed end fixed to the base portion, and a latching end at the other end thereof, which is engaged with a stepped portion formed at a boundary between the main body and the head portion, and including an elastic part between the fixed end and the latching end.

However, in Patent Document 1 described above, when mounting a guide blade for use, only a limited product conforming to a predetermined standard can be used. Accordingly, because only a product from a predetermined maker can be used, various types of guide blades cannot be used, resulting in a problem in which the hair styling is very limited.

In addition, in Patent Document 2, while the elastic fixing piece provided on a rear portion of the guide blade (comb tooth cap) is configured to be fixed to the end of the hair clipper, to allow easy attachment and detachment of the guide blade irrespective of the makers or models of the electric hair clipper, there is a shortcoming that it can be applied only to the electric hair clipper that is the detachable-type hair clipper, but cannot be attached to the fixed-type hair clipper.

Further, when the elastic force of the elastic fixing piece is deteriorated, the tight fixation between the guide blade and the hair clipper cannot be maintained. However, because the elastic fixing piece and the base portion are integrally formed with each other, it is not possible to replace only the elastic fixing piece, so there is a problem in that a new guide blade need to be purchased after a certain period of time.

### SUMMARY

In order to solve the problems mentioned above, the present disclosure has been devised in consideration of the background art described above, and it is desirable to provide a universal guide blade for a hair clipper, which can be used for an electric hair clipper including both a fixed-type hair clipper and a detachable-type hair clipper and which can be replaced with ease and convenience.

In addition, it is desirable to provide a universal guide blade for a hair clipper, to which a fixing member for providing a predetermined elastic force is detachably attached such that, when the elastic force of the fixing member is deteriorated, it is possible to separately replace only the fixing member.

Further, it is desirable to provide a universal guide blade for a hair clipper, which is capable of minimizing deterioration of the elastic force of a fixing member fixed thereto even when the fixing member is maintained in the fixed state for a long time, by providing a predetermined supporting force to the fixing member.

However, it should be understood that the scope of the present disclosure is not limited thereto and that, even if not explicitly mentioned herein, the objects and effects which can be understood from the means for solving the problems and the embodiments of the present disclosure are also included therein.

According to an embodiment of the present disclosure, there is provided a universal guide blade for a hair clipper, which may include: a guide body having a cutting guide formed on a front side, and a plurality of attaching grooves spaced apart from each other at predetermined intervals formed on a rear side of the cutting guide; a guide fixing part formed at a center of a rear side of the guide body and having a mounting protrusion for fixing to and separating from a detachable-type hair clipper; and a fixing member inserted into the attaching grooves and fixing the guide blade to a fixed-type hair clipper by a predetermined elastic force.

In one embodiment, the guide body may further include a supporting jaw protruding upward from one side of the plurality of attaching grooves and preventing the fixing member from being separated from the attaching grooves.

In one embodiment, the fixing member may include: a mounting part inserted into the attaching grooves in a sliding manner and fixed in position; an elastic part extending from a rear portion of the mounting part and providing a predetermined elastic force; and a coupling plate integrally formed at an end of the elastic part and fixed to a blade fixing part of the fixed-type hair clipper.

In one embodiment, the guide fixing part may further include a grip part formed at a position facing the mounting protrusion and gripped for detachment from the detachable-type hair clipper.

In one embodiment, the guide body may further include a supporting means having one end coupled to the guide fixing part, and the other end pressing the fixing member.

According to the embodiments of the present disclosure as described above, there is an effect that the guide blade can be easily and conveniently attached to and detached from the electric hair clipper including both the fixed-type hair clipper and the removable hair clipper.

In addition, according to the embodiments of the present disclosure, when the elastic force of the fixing member is deteriorated due to the fixing member for providing a predetermined elastic force being detachable and attachable, there is an effect that only the fixing member can be separately replaced and continue to be used.

In addition, according to the embodiments of the present disclosure, by providing a predetermined supporting force to the fixing member side when the guide blade is fixed, there is an effect that the deterioration of the elastic force of the fixing member can be minimized even when the fixing member is maintained in the fixed state for a long time.

Further, the various and beneficial advantages and effects of the present disclosure are not limited to the above description and can be more easily understood in the course of describing a specific embodiment of the present disclosure.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIGS. 1 and 2 are perspective views showing a universal guide blade for a hair clipper according to an embodiment of the present disclosure;

FIGS. 3 and 4 are a plan view and a bottom view showing a universal guide blade for the hair clipper according to an embodiment of the present disclosure;

FIG. 5 is an enlarged sectional view showing a main part of a universal guide blade for a hair clipper according to an embodiment of the present disclosure;

FIGS. 6 and 7 are views showing a support structure of a universal guide blade for a hair clipper according to an embodiment of the present disclosure; and

FIGS. 8 and 9 are views showing a universal guide blade for a hair clipper according to an embodiment of the present disclosure in a mounted state.

### DETAILED DESCRIPTION OF THE DISCLOSURE

Hereinafter, preferred embodiments according to the present disclosure will be described in detail with reference to the accompanying drawings. It should be noted that, in adding reference numerals to the constituent elements of the drawings, the same constituent elements are denoted by the same reference numerals even if they are illustrated in different drawings. Further, in explaining the present disclosure, any specific explanation on a well-known related configuration or function deemed to obscure the gist of the present disclosure will be omitted.

Further, in describing the elements of the present disclosure, the terms such as “first,” “second,” “A,” “B,” “(a),” “(b)” and so on may be used. However, these terms are used solely for the purpose of distinguishing one element from another, and the terms do not limit the nature, sequence or order of the corresponding elements. When a component is described as being “connected”, “coupled”, or “connected” to other components, the component may be directly connected or connected to the other components, it is to be understood that another component may be connected, coupled, or connected between each component.

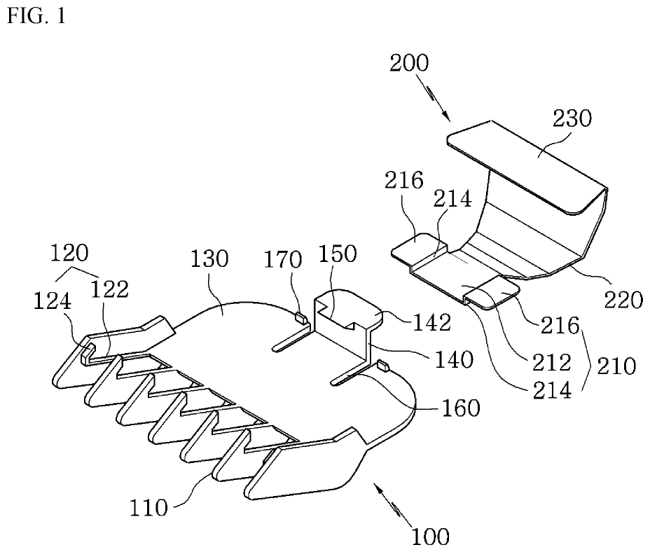

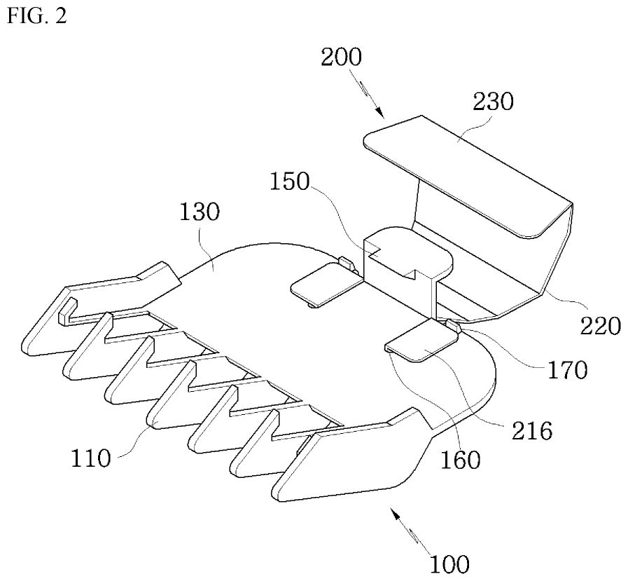

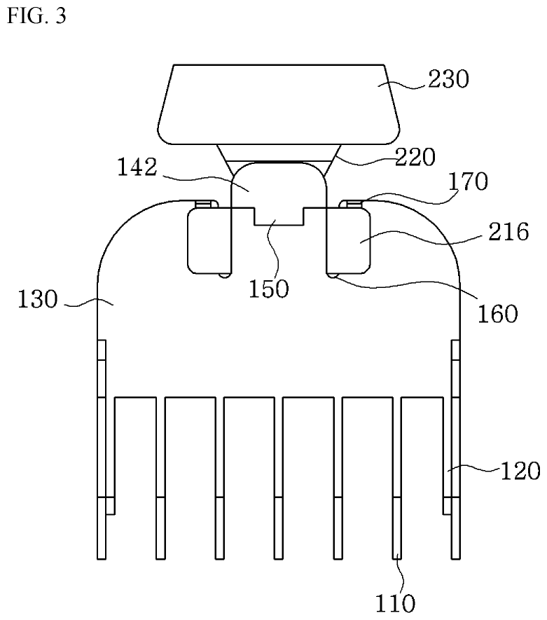

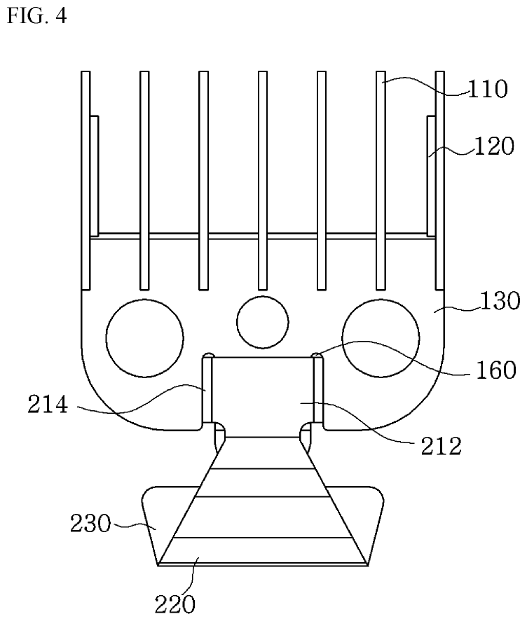

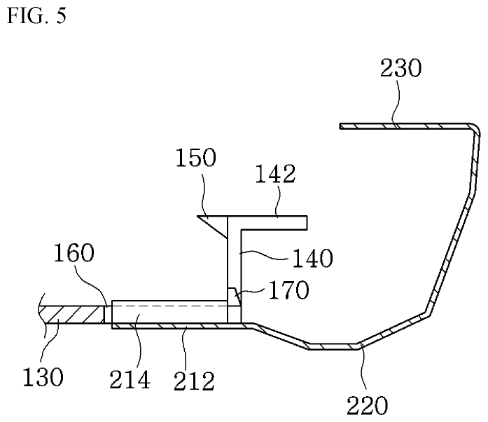

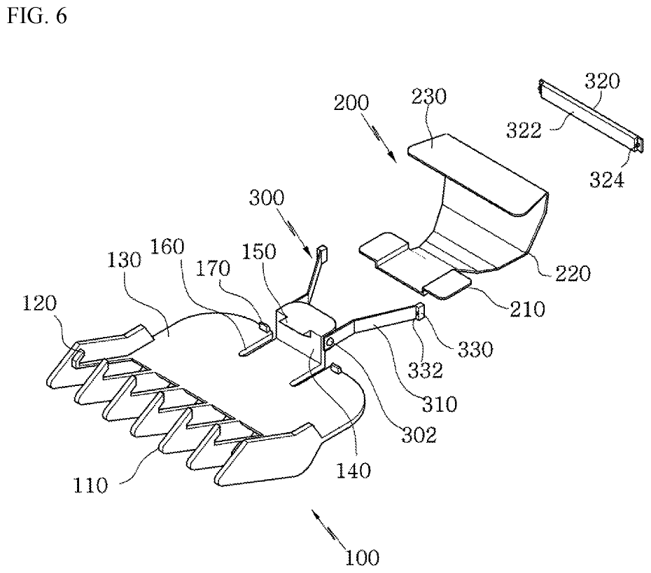

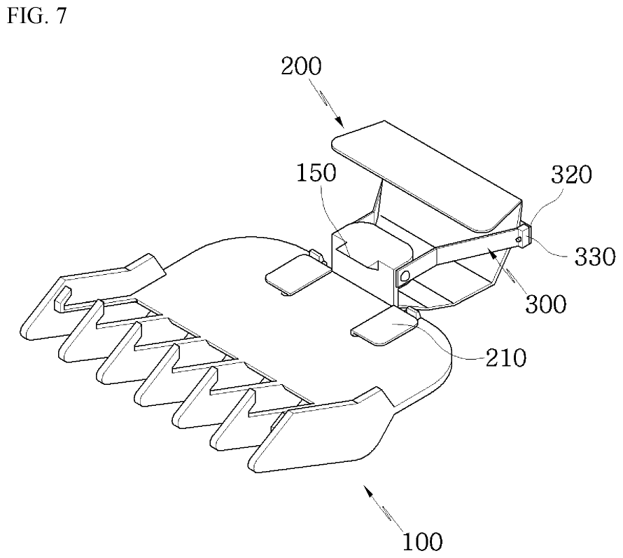

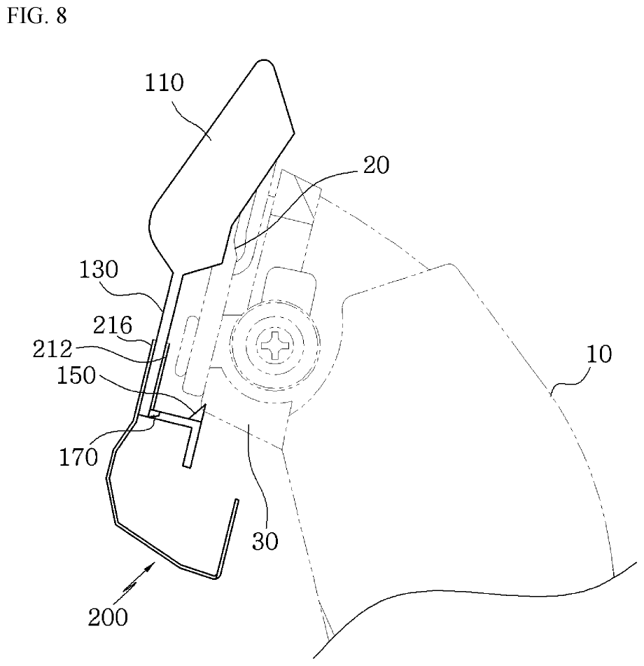

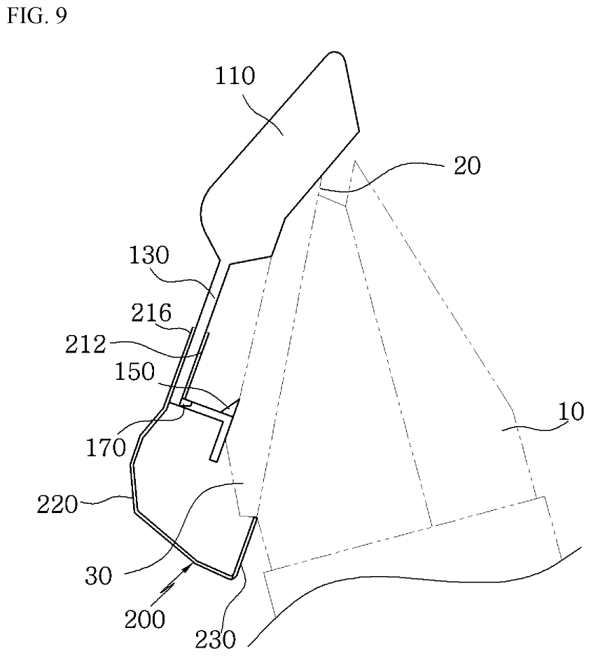

FIGS. 1 and 2 are perspective views showing a universal guide blade for a hair clipper according to an embodiment of the present disclosure, FIGS. 3 and 4 are a plan view and a bottom view showing a universal guide blade for a hair clipper according to an embodiment of the present disclosure, FIG. 5 is an enlarged sectional view showing a main part of a universal guide blade for a hair clipper according to an embodiment of the present disclosure, FIGS. 6 and 7 are views showing a support structure of a universal guide blade for a hair clipper according to an embodiment of the present disclosure, and FIGS. 8 and 9 are views showing a universal guide blade for a hair clipper according to an embodiment of the present disclosure in a mounted state.

As shown in the drawings, the universal guide blade for a hair clipper according to the present disclosure includes a main body 100, a fixing member 200 and a supporting means 300.

The main body 100 includes a cutting guide 110 which is formed on a front side and into which human head hair, animal hair, and the like are entered, and a guide body 130 extending from a rear portion of the cutting guide 110 and brought into close contact with a bottom surface of the hair clipper 10.

The cutting guide 110 is configured such that a blade of a cutting portion 20 formed on a leading end of the hair clipper 10 is seated thereon, and includes a plurality of cutting guides spaced apart from each other at predetermined intervals so that the hair to be cut or the like is entered and the hair that is cut is exited therethrough.

The cutting guide 110 includes holders 120 formed on both sides in a corresponding shape, and each holder 120 includes a seating panel 122 on which a bottom surface of the blade of the cutting portion 20 is seated closely, and a holding panel 124 which is bent at an end of the seating panel 122, and on which a blade tip of the cutting portion 20 is held.

The guide body 130 is integrally formed on a rear portion of the cutting guide 110, and is configured to closely contact a bottom surface of the hair clipper 10 when the hair clipper 10 is coupled with the main body 100, and ensure stable fixing between the guide blade of the present disclosure and the hair clipper 10.

The guide body 130 includes a attaching groove 160 to which the fixing member 200 is coupled so that the hair clipper 10 is fixed to the rear portion, and a guide fixing part 140 fixed to and separated from the detachable-type hair clipper 10 of the hair clipper 10.

The attaching groove 160 is formed at a center of the rear side of the guide body 130 and formed of a plurality of grooves spaced apart from each other by a predetermined distance to allow mounting parts 210 of the fixing member 200 to be coupled in a sliding manner.

The guide fixing part 140 is formed between the plurality of attaching grooves 160 and may be a panel that is vertically bent upward from the guide body 130, and includes a mounting protrusion 150 formed at an upper end thereof to be fixed to a stepped portion of a blade fixing part 30 formed on the detachable-type hair clipper 10.

The mounting protrusion 150 protrudes from an upper end of the guide fixing part 140 toward the cutting guide 110 and is formed in a shape of a triangle of which a lower side is gradually narrowed toward the tip of the mounting protrusion 150.

The guide fixing part 140 may be configured to provide a predetermined elastic force so that the mounting protrusion 150 and the blade fixing part 30 are tightly fixed and then easily separated.

In addition, the guide fixing part 140 may further include a grip part 142 at a position facing the mounting protrusion 150.

The grip part 142 is provided for a grip by a user when the user attempts to separate the guide blade fixed to the detachable-type hair clipper 10. Accordingly, pulling the grip part 142 causes the mounting protrusion 150 to be separated from the blade fixing part 30.

That is, to fix the guide blade 142 to the detachable-type hair clipper 10, the mounting protrusion 150 is fit into the blade fixing part 30, and to separate the guide blade 142, the grip part 142 is pulled so that the fitting between the mounting protrusion 150 and the blade fixing part 30 is released.

In addition, the guide body 130 includes a supporting jaw 170 for preventing the fixing member 200 from being inadvertently separated from the attaching groove 160.

The supporting jaws 170 may be formed on both sides of the attaching groove 160, and prevent the fixing member 200 inserted into the attaching groove 160 from escaping from the attaching groove 160 due to the elastic force generated when the fixing member 200 is engaged with the fixed-type hair clipper 10, and the supporting jaw 170 is in close contact with a rear end of the elastic fixing panel 216 of the fixing member 200, which will be described below.

The supporting jaw 170 has a predetermined inclined surface on a rear portion thereof so that the fixing member 200 may be easily slid thereon and inserted into the attaching groove 160, and also has a vertical surface on a front portion thereof to be in a close contact with an elastic fixing panel 216.

Although not shown in the drawings, the supporting jaw 170 may further include a panel insertion groove (not shown) recessed from the vertical surface so that the rear end of the elastic fixing panel 216 may be inserted and fixed in position.

The fixing member 200 is coupled to the rear portion of the guide body 130 and fixes the guide blade to the fixed-type hair clipper 10, and includes a mounting part 210 to be inserted into the attaching grooves 160 of the guide body 130 in a sliding manner and fixed in position; an elastic part 220 extending from the rear portion of the mounting part 210 and providing a predetermined elastic force upon fixing to the fixed-type hair clipper 10; and a coupling plate 230 to be fixed to the blade fixing part 30 of the fixed-type hair clipper 10.

The mounting part 210 is formed on a front end of the fixing member 200 and inserted into the attaching groove 160 formed in the guide body 130 and fixed in position, so that the guide body 130 is fixed to, or separated from the fixed-type hair clipper 10.

The mounting part 210 includes: a bottom panel 212 to be brought into a close contact with a lower surface of the guide body 130 during insertion into the attaching groove 160 and having the elastic part 220 extending to a rear side; guide panels 214 extending vertically from both sides of the bottom panel 212 and guiding the insertion of the fixing member 200 while being brought into a close contact with the inner wall surface of the attaching groove 160 during insertion into the attaching groove 160; and elastic fixing panels 216 bent vertically from upper ends of the guide panel 214 and slidably moved with lower surfaces thereof kept in close contact with the upper surface of the guide body 130 when the mounting part 210 is inserted.

The mounting part 210 allows the guide body 130 and the fixing member 200 to be tightly fixed to each other, while also allowing the elastic part 220 to generate elastic force due to bending when coupled with the fixed-type hair clipper 10.

The mounting part 210 of the present disclosure configured as described above may be fixedly coupled to the plurality of attaching grooves 160 formed in the guide body 130, but not limited thereto. Accordingly, the mounting part 210 may be separable from the attaching groove 160 by using the elastic force of the elastic fixing panel 216.

In this case, to separate the fixing member 200 from the attaching groove 160, the elastic fixing panels 216 may be lifted upwardly so that bending occurs and the lower surfaces of the elastic fixing panels 216 are placed on the upper surfaces of the supporting jaws 170, and then the fixing member 200 may be pulled backward to be separated.

When the elastic force of the elastic part 220 of the fixing member 200 is decreased to an extent that it is difficult to maintain the fixing force of the guide blade and the fixed-type hair clipper 10 for a desired time, the fixing member 200 may be easily and conveniently separated from the guide body 130 for replacement, so that it is possible to solve the problem of having to purchase the entire guide blade as in the conventional art.

The elastic part 220 provides a predetermined elastic force to fix and separate the guide blade of the present disclosure to and from the fixed-type hair clipper 10, to result in coupling between the coupling plate 230 and the blade fixing part 30 of the fixed-type hair clipper 10 or de-coupling thereof, and is formed integrally with the rear portion of the bottom panel 212 and bent at various angles, and includes a coupling plate 230 formed at an end of the elastic part 220.

The elastic part 220 is formed between the bottom panel 212 and the coupling plate 230 and includes two or more unit panels that are integrally formed and bent in a predetermined angle.

In addition, the elastic part 220 is configured such that a unit panel adjacent to the bottom panel 212 and a unit panel adjacent to the coupling plate 230 provide different elastic forces from each other.

That is, when the coupling plate 230 and the blade fixing part 30 are fixed, the elastic force provided by the unit panel adjacent to the coupling plate 230 is greater than the elastic force provided by the unit panel adjacent to the bottom panel 212, so that the coupling plate 230 may be seated on the blade fixing part 30 and fixed in position even with a small force.

The coupling plate 230 is bent at the end of the elastic part 220 and seated on the blade fixing part 30 of the fixed-type hair clipper 10 and fixed in position to fix the guide blade to the fixed-type hair clipper 10.

The coupling plate 230 is configured such that, when the user applies force to the elastic part 220 from the bottom panel 212 in the downward direction, the coupling plate 230 is located on the blade fixing part 30, and when the pressing force is removed, the coupling plate 230 is moved by the elastic restoring force of the elastic part 220 to be engaged with the blade fixing part 30.

As shown in FIGS. 6 and 7, in an embodiment, a supporting means 300 may be further provided, which may prevent the coupling plate 230 from being separated from the blade fixing part 30 by the elastic restoring force of the elastic part 220 or due to vibration generated when the fixed-type hair clipper 10 is used, and also minimize the deterioration of the elastic force of the elastic part 220.

The supporting means 300 includes a support panel 310 having one end coupled to both sides of the upper portion of the guide fixing part 140 and the other end brought into a close contact with both sides of the elastic part 220, and a pressing panel 320 separably coupled to an end of the support panel 310 and pressing an outer surface of the elastic part 220.

The one end of the support panel 310 is coupled to the both ends of the guide fixing part 140 by a coupling means such as riveting, screw, and so on, and the other end is brought into contact with both sides of the elastic part 220, and the support panel 310 further includes a fastening bracket 330 to which the pressing panel 320 is detachably coupled.

The fastening bracket 330 includes a fitting hole 332 into which a coupling shaft 324 formed on the pressing panel 320 is coupled by force-fitting.

The support panel 310 is inclined at a central portion thereof by a predetermined angle so as to be kept in contact with both sides of the elastic part 220, while providing a predetermined elastic force. Accordingly, even when the area of the elastic part 220 is larger than the space between the support panels 310, the elastic force of the support panel 310 allows easy coupling with the guide body 130.

The pressing panel 320 is detachably coupled to the fastening bracket 330 formed on the support panel 310 and presses the outer surface of the elastic part 220 to prevent the elastic force from being excessively generated by the elastic part 220 and also to provide a certain elastic force to the coupling plate 230 so that the coupling plate 230 is prevented from being inadvertently separated from the blade fixing part 30.

The pressing panel 320 includes the pressing part 322 in contact with the outer surface of the elastic part 220 and pressing the elastic part 220 when engaged with the coupling bracket 330, and the coupling shaft 324 for coupling the pressing panel 320 to the coupling bracket 330.

At this time, the pressing panel 320 may include flanges having the coupling shafts 324 formed thereon on both sides, respectively, and the flanges may be adjustable in length to allow coupling with the fastening bracket 330 formed on the support panel 310 by force-fitting.

In this example, rails and the rail grooves may be formed in the pressing panel 320 and the flanges, respectively, for the purpose of length adjustment, although not limited thereto.

It is to be understood that the terms “comprise”, “include”, or “have” as used herein may mean that the component can be inherently included unless specifically stated to the contrary, and therefore, should be construed as further including other elements rather than exclude other components, all terms including technical or scientific terms have the same meaning as commonly understood by one of ordinary skill in the art to which this invention belongs, unless otherwise defined.

In addition, the present disclosure has been described in detail. However, it should be understood that the detailed description and specific examples, while indicating preferred embodiments of the disclosure, are given by way of illustration only, since various changes and modifications within the scope of the disclosure will become apparent to those skilled in the art from this detailed description. Accordingly, the embodiments disclosed in the present disclosure are provided to explain, not to limit a technical art of the present disclosure, and thus, the scope of the present disclosure is not limited. The scope of the present disclosure should be construed by following claims, and every technical art within a same scope of the following claims should be construed to be included in a scope of a right of the present disclosure.

What is claimed is:

1. A universal guide blade for a hair clipper, comprising:
a guide body having a cutting guide formed on a front side, and a plurality of attaching grooves spaced apart from each other at predetermined intervals formed on a rear side of the cutting guide;
a guide fixing part formed at a center of a rear side of the guide body and having a mounting protrusion for fixing to and separating from a detachable-type hair clipper; and
a fixing member inserted into the attaching grooves and fixing the guide blade to a fixed-type hair clipper by a predetermined elastic force.

2. The universal guide blade according to claim 1, wherein the guide body further comprises a supporting jaw protruding upward from one side of the plurality of attaching grooves and preventing the fixing member from being separated from the attaching grooves.

3. The universal guide blade according to claim 1, wherein the fixing member comprises:
a mounting part inserted into the attaching grooves in a sliding manner and fixed in position;
an elastic part extending from a rear portion of the mounting part and providing a predetermined elastic force; and
a coupling plate integrally formed at an end of the elastic part and fixed to a blade fixing part of the fixed-type hair clipper.

4. The universal guide blade according to claim 1, wherein the guide fixing part further comprises a grip part formed at a position facing the mounting protrusion and gripped for detachment from the detachable-type hair clipper.

5. The universal guide blade according to claim 1, wherein the guide body further comprises a supporting means having one end coupled to the guide fixing part, and the other end pressing the fixing member.
